(19) United States
(12) Patent Application Publication
(10) Pub. No.: US 2007/0267250 A1
(43) Pub. Date: Nov. 22, 2007

(54) Electric human lift

(76) Inventor: Richard J. Wolff, Yakima, WA (US)

Correspondence Address: Galasso & Associates, LP, P.O. Box 26503, Austin, TX, 78755-0503, US

(21) Appl. No.: 11/437,309

(22) Filed: May 19, 2006

(51) Int. Cl. E06C 7/16

(52) U.S. Cl. 182/103

(57) ABSTRACT

A portable free-standing electric human lift apparatus is provided for electrically raising or lowering a human or materials on a three legged ladder-like frame. The ladder-like frame having the general form of a three legged orchard ladder with a fixed top platform sitting atop of two opposing substantially parallel distally spaced elongated front legs. The front legs having an extruded ‘U’ shaped channel cross section. A stabilizing back leg is pivotally connected at the top end of the leg to the platform member, to swing out and form a tripod-like or third leg support to stabilize the lift to stand freely in a vertical position. A leveling means provided on the bottom portion front legs serves to level the lift apparatus when resting upon an uneven surface. A movable load bearing platform is slidably retained in the ‘U’ channel track between the front legs, the movable platform being electrically driven so as to raise the platform to an elevated position or alternately lower the platform, the platform for bearing and raising a human or material load upon the ladder-like human lift apparatus.

### FIELD OF THE DISCLOSURE

The disclosures made herein relate generally to electrically driven portable lift apparatus, and more particularly to portable free-standing apparatus for lifting or raising a human or other materials up a ladder-like frame using electric drive means commanded by a wireless remote control.

### BACKGROUND

Craftsmen and tradesmen use a variety of tools for completing the work of their trades. All craftsmen, particularly those in the construction and remodeling trades, have a need for the use of a ladder in their work. Ladders can be found almost everywhere, in the home, on the job site, and in businesses. Ladders come in different types and sizes. Ladders are used for a variety of tasks such as painting walls, installing siding, framing buildings, reaching elevated roofs for roofing or re-roofing, trimming elevated branches in trees, and many additional uses.

Workmen and craftsmen climb and descend ladders frequently in the completion of the tasks of their trade, often while carrying tools and other materials. However, climbing and descending conventional ladders throughout the work day can be tiring, even more so for tradesmen with bad knees or other temporary or permanent physical handicaps and injuries.

Therefore, a free-standing electric human lift for raising a workman to an elevated work position, an electric lift that is transportable, an electric lift that overcomes the limitations of the prior art and makes repetitive use of a ladder less stressful to the human body and reduces the required effort for a task, such an electric human lift apparatus would be useful and novel.

### SUMMARY OF THE DISCLOSURE

Accordingly, embodiments of the inventive disclosures made herein comprise various embodiments of a free-standing electric human lift apparatus for electrically raising or lowering a human or materials at various positions upon a ladder-like frame.

In a first embodiment of the inventive disclosures made herein, electric human lift comprises a ladder-like frame having the general form of a three legged orchard ladder. The ladder-like frame having a fixed top platform member as in a conventional step ladder, but without the fixed step rungs of a step ladder. The platform sits atop two opposing substantially parallel distally spaced elongated front legs, top end of the legs being connected to opposing sides of the top platform member. The front legs have a ‘U’ shaped channel cross section, which is to say they are in the form of extruded metallic channel stock. The channels are in opposing facing arrangement, each on an opposing front leg. Each channel is disposed substantially along the length of the front leg. The channel forms a guide track in which the rollers of a load bearing platform are retentively guided. A stabilizing back leg is pivotally connected at the top end of the leg to the platform member. The pivotal back leg, or third leg, stabilizes the ladder-like frame so that it can stand freely in a vertical position without leaning against another object or surface for support. The third leg, when extended, provides an ‘A’ shaped step ladder-like side profile to the ladder-like frame.

The electric human lift ladder-like frame has a leveling means secured to a bottom portion of the front legs. The leveling means serves to level the ladder-like lift apparatus when it rests upon an uneven surface or ground. An electrically driven movable load bearing platform is slidably fixed between the front legs, the movable platform for raising or lowering a human or material load on the ladder-like human lift apparatus to an elevated position. The movable platform has a trolley frame having two substantially parallel distally spaced elongated trolley arms. Four axles are secured to the trolley arms, two per arm. Each axle has a first end secured to an opposing end of the trolley arms. Four roller wheels are provided, one on each axle. Each roller wheel has a cylindrical bearing therein for receiving the axle and rolling on the axle. The roller circumference and size is adapted to roll within the ‘U’ shaped channel of the elongated front legs of the ladder-like frame as discussed above. The rollers are fixed to the axle such that the roller spins freely on the axle. A substantially horizontal load bearing platform member is provided for the human or material to stand upon while riding the electric human lift. The load platform has a ridged slip resistant surface for supporting a human thereon. The load platform member is secured on opposing sides to the opposing arms of the trolley frame. A substantially horizontal elongated leg support is provided, connected between two trolley legs, the leg support positioned above the load platform such as to provide leaning leg support to a human standing on the load platform. The movable platform is raised and lowered by means of an electrically driven motor secured to the ladder-like frame. For operating the human lift apparatus, a wireless remote control transmitter is provided, the transmitter having a clip attached thereto to allow the remote control to be clipped onto a belt, strap or pants pocket. The wireless remote control transmitter having controls thereon to command the movable load bearing platform to raise or lower within the tracks of the ladder-like frame. The remote control communicates with a wireless remote control receiver and motor controller unit secured to the ladder-like frame, the receiver for receiving the raise lower commands and the controller for energizing the motor in response to the commands. The controller selectively rotates the output shaft of the motor to accomplish raising or lowering the moveable platform along the guide track ‘U’ channel. A power supply means for providing electric power to operate the winch and receiver is electrically connected to the receiver and motor. As an important aid to safety, a brake means is provided. The brake means automatically engages and frictionally brakes the rotating shaft of the motor and winch so as to prevent the winch from turning under the weight of the load on the movable platform. The brake means releases automatically during commanded operation of the winch and then later re-engages after the command completes. The brake means is envisioned as electrically operated and is intended to be of the fail-safe variety wherein the brake must be energized to release and then de-energized to re-engage. In the event of a power failure to the motor drive means, the brake is automatically applied and remains applied, locking the movable platform at its last position.

Two transport wheels are rollably secured near the front edge of the load bearing platform at opposing sides of the platform. The wheels provide a means of rolling the electric human lift from place to place by grasping the top platform member or grasping the elongated legs and tilting the electric human lift forwards until the electric human lift rides upon the platform load transport wheels. At this point the electric human lift can be balanced on the wheels and rolled from location to location as needed without needing the need for a human to carry the weight of the apparatus.

In a second embodiment of the inventive disclosures made herein, the electric human lift apparatus of the first embodiment is modified to have an electrically motor driven means having a winch secured to the ladder-like frame. The winch is driven by an output shaft of the motor. The winch drives a cable drum spool. A pulley and cable means is incorporated to raise and lower the platform by way of the electric drive means. The cable means is secured at one end of the movable platform. The cable means is windably received upon the cable drum of the winch. The winch operating in response to the commands to spool or despool cable from the winch cable spool.

In a third embodiment of the inventive disclosures made herein, the electric human lift apparatus of the second embodiment is modified to have a ladder leveling means comprising two ladder leveling devices, one device on the bottom portion of each front leg for the ladder-like frame. Each leveling device comprises a ‘U’ shaped channel leveling member having a slot through a portion of a back wall of the channel, and wherein the channel of the leveling member is sized and adapted to be slidably received over the bottom portion of a front leg of the ladder-line frame. The leveling member is slidable along a portion of the length of the leg so as to adjust the length of the leg by extending the leg, when necessary, to level the ladder-like frame on an uneven surface. A threaded rod is secured at one end to a bottom portion of the front leg. The threaded rod projects outwards from the leg and through the slot of the leveling member. A threaded hand adjustable tensioning knob is threadably received onto an outwards end of the threaded rod. The tensioning knob, when tightened, compresses the leveling member to the leg thereby frictionally fixing the leg extension for leveling the ladder-like frame at its current leveling extension.

In a fourth embodiment of the inventive disclosures made herein, the electric human lift apparatus of the third embodiment has the ladder-like frame further comprising a substantially flat base plate secured to the bottom end of the front legs of the ladder-like frame. The base plate has the winch and electric motor drive means secured onto the plate at the bottom of the electric human lift.

In a fifth embodiment of the inventive disclosures made herein, the electric human lift apparatus of the fourth embodiment has a pulley and cable means comprising a first pulley wheel rotably mounted to an underside of the fixed top platform member at the top of the ladder-like frame. A cable is threaded over and riding on the first pulley wheel, where a first end of the cable secured to the moveable platform and a second end of the cable secured to and windably received upon the cable drum of the winch.

In a sixth embodiment of the inventive disclosures made herein, the electric human lift apparatus of the fifth embodiment has a power supply means comprising a conventional 115 volt electrical utility power source supplied through a conventional power cord from an electrical receptacle.

In a seventh embodiment of the inventive disclosures made herein, the electric human lift apparatus of the fifth embodiment has a power supply means comprising a rechargeable storage battery.

In an eighth embodiment of the inventive disclosures made herein, the electric human lift apparatus of the seventh embodiment has a power supply means comprising one or more wet cell automotive type 12 volt batteries.

It is an objective of the inventive disclosure made herein to an electric human lift which is not anticipated, rendered obvious, suggested, or implied by the known prior art in electric ladder lifts.

It is another objective of the present inventive disclosures to provide a new electric human lift which is portable and may be transported to a worksite for use as well as moved around the work sites as needed to work at and to reach elevated heights.

It is another objective of the present inventive disclosures to provide a new electric human lift which can be operated in the absence of or unavailability of utility electric power supply.

It is another objective of the present inventive disclosures to provide a new electric human lift which has improved safety features due to a fail-safe braking means.

It is another objective of the present inventive disclosures to provide a new electric human lift which is adaptable to use on uneven or sloping ground.

It is another objective of the present inventive disclosures to provide a new electric human lift which is free-standing and does not need to lean or rest against another object or supportive wall to remain erect.

It is another objective of the present inventive disclosures to provide a new electric human lift which can be operated by remote control, wherein the operator clips and wears the wireless remote control to an article of clothing being worn such as a belt, strap or pants pocket, for example.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of one embodiment of the electric human lift in accordance with the inventive disclosures herein.

FIG. 2 depicts an enlargement of the moveable platform support trolley frame and roller wheels in accordance with the inventive disclosures herein.

FIG. 3 depicts a side view of one embodiment of the electric human lift in accordance with the inventive disclosures herein.

FIG. 4 depicts a perspective view of one embodiment of the wireless remote control for the electric human lift in accordance with the inventive disclosures herein.

FIG. 5 depicts a an enlargement of the transport wheels mounted near the front edge of the movable platform in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

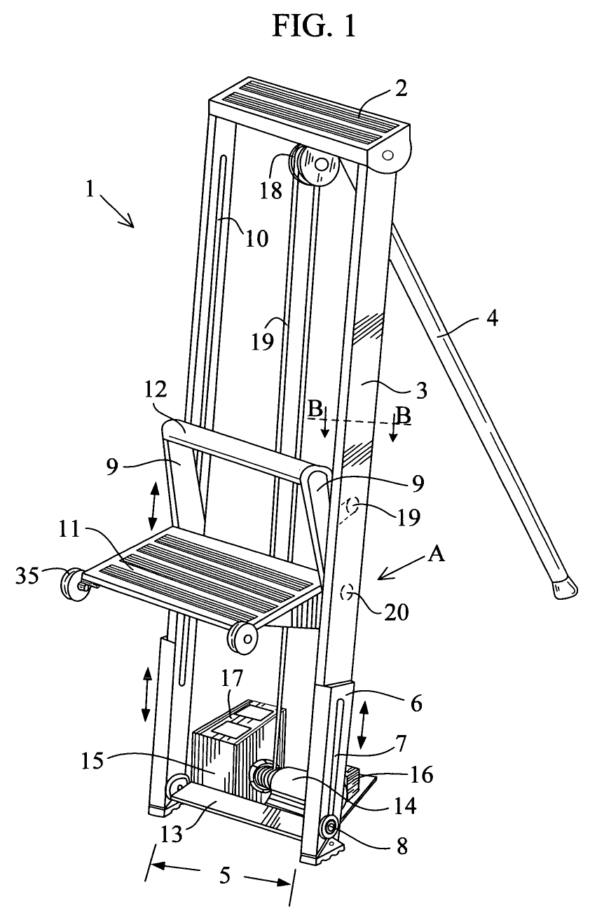

Turning now to FIG. 1. FIG. 1 depicts a perspective view of one embodiment of the electric human lift in accordance with the inventive disclosures herein. An electric human lift apparatus 1 comprises a ladder-like frame having the general form of a three legged orchard ladder. The ladder-like frame having a fixed top platform member 2, two opposing substantially parallel distally spaced elongated front legs 3 with the top end of the legs connected to opposing sides of the top platform member 2. The legs are preferably of extruded aluminum stock, extruded into a member having ‘U’ shaped channel cross section. A stabilizing back leg 4 is pivotally connected at a top end to the platform member 2. The stabilizing leg stabilizing the ladder-like frame enabling the ladder frame to stand erect without tipping. The back support leg or third leg provides a generally ‘A’ shaped step ladder-like side profile to the ladder-like frame. Preferably the electric human lift has a standing height of between 8 to 12 feet, and the spacing between the front legs 5 is nominally 2 feet, although the invention is not limited to these dimensions. The bottom portion of the front legs each has a ladder leveling device secured thereto. Each ladder leveling device comprises a ‘U’ shaped channel leveling member 6 having a slot 7 through a portion of a back wall of the channel. The channel 7 of the leveling member sized and adapted to be slidably received over a bottom portion of the front leg 3, the leveling member slidably-adjustable along the leg 3 so as to adjust the length of the leg and thereby level the ladder-like frame on an uneven surface.

A threaded rod secured at one end to a bottom portion of the front leg and projects outwards through the slot 7 of the leveling member, then engaging a threaded hand adjustable tensioning knob 8 which is threadably received onto an outwards end of the threaded rod. The tensioning knob is operated by twisting the knob by hand to compress the leveling member 6 against the leg 3 to frictionally fix the leveling leg extension 6 in position for leveling the ladder-like frame.

The electric human lift includes a movable platform for raising or lowering a human or material load on the ladder-like human lift apparatus. The movable platform comprises a trolley frame having two substantially parallel distally spaced elongated trolley arms 9, each arm having two opposing ends. Four steel axles, two on each trolley arm, have a first end secured to the trolley arm. Each axle is sized and configured to receive a steel roller wheel, each roller having a cylindrical bearing for rolling on the axle and the roller circumference and size adapted to roll within the ‘U’ shaped channel 10 of the elongated front legs 3. The roller wheels are fixed to the axle such that the roller spins freely on the axle. The substantially horizontal load platform member 11 has a ridged slip resistant surface for supporting a human thereon. The load platform member is secured on opposing sides to the opposing arms 9 of the trolley frame. The load platform includes a substantially horizontal elongated leg support rest 12 having two ends, each secured to opposing trolley arms The leg support 12 is positioned above the load platform 11 such as to provide leaning leg support to a human standing on the load platform. A substantially flat base plate 13 secured to a bottom end of the front legs 3. An electric drive motor 14 is secured to a base plate 13 of the ladder-like frame. The winch 15 is secured to the base plate 13, the winch being driven by the output shaft of the motor 14, the winch having and driving a cable drum.

A wireless remote control receiver 16 and motor controller unit is secured to a base, the receiver for receiving the raise and lower commands from the wireless remote control unit. The motor controller energizes the motor in response to the raise and lower commands from the remote control, the controller selectively rotating the output shaft of the motor to raise or lower the moveable platform 11. Power is provided by one or more automotive, similar or larger type twelve volt rechargeable storage batteries 17 secured to the base plate. The battery provides electric power to drive the motor and operate the winch and wireless receiver. A first pulley wheel 18 is rotably mounted to an underside of the fixed top platform member 2. A cable 19 is threaded over and riding on the first pulley wheel 18, a first end of the cable secured to the moveable platform, a second end of the cable secured to and windably received upon the cable drum of the winch, wherein the cable winds or unwinds from the drum according to the commands.

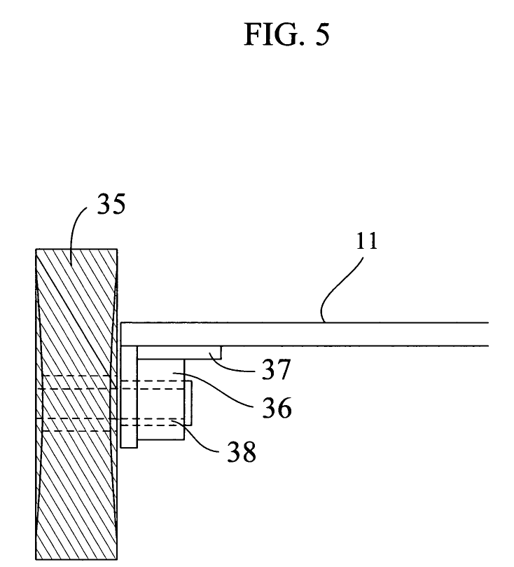

Transport wheels 35 are rollably secured proximate to the front edge of platform 1 at opposing sides of the platform 11. The wheels are free to roll upon an axle and axle support shown later in FIG. 5. The wheels provide a means of rolling the electric human lift from place to place as follows. From the standing position as illustrated, the electric human lift is tilted forwards by grasping the top platform member 2 or grasping elongated legs 3 and tilting the electric human lift forwards until the electric human lift ride on platform load transport wheels 35. At this point the electric human lift can be balanced on the wheels and rolled from location to location as needed.

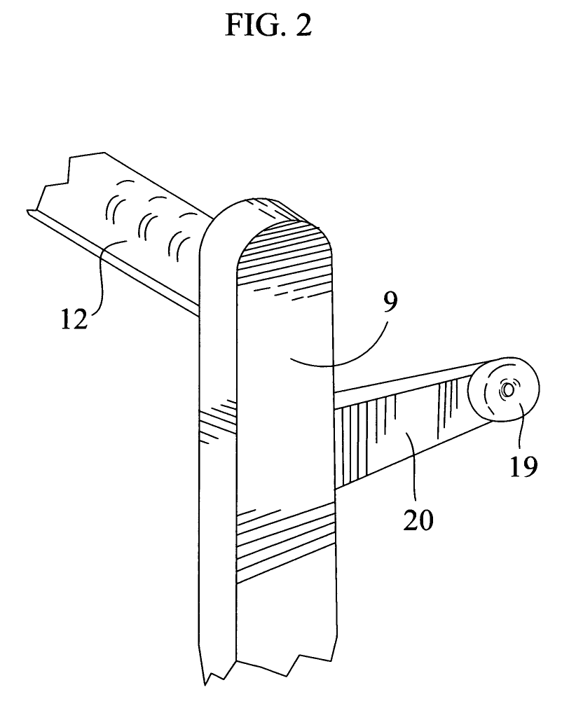

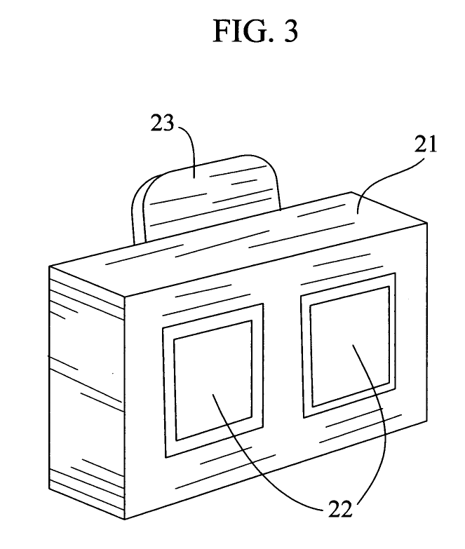

FIG. 2 detail ‘A’ depicts an enlargement of the moveable platform support trolley arm 9 and roller wheels in accordance with the inventive disclosures herein. Referring to FIG. 3 with FIG. 2 in view, the upper roller wheel 19 is attached to the trolley arm 9 by an extension tab 20 secured to the trolley arm. The tab permits the trolley arm to remain in a substantially vertical position while the ladder legs 3 are sloped for stability of the ladder-like frame. Both the upper roller wheel 19 and lower roller wheel 20 roll within and are retained within the ‘U’ shaped channel 10 of the legs 3. The elongated leg support rest 12 is attached between upper ends of the trolley arms 9.

FIG. 3 depicts a perspective view of one embodiment of the wireless remote control for the electric human lift in accordance with the inventive disclosures herein. Remote control unit 21 is provided with a clip 23 on the back of the unit permitting the remote control to be secured to an article of clothing such as a belt, strap or pants pocket, for example. Control switches 22 for raising and lowering the platform are provided on the face of the remote control unit.

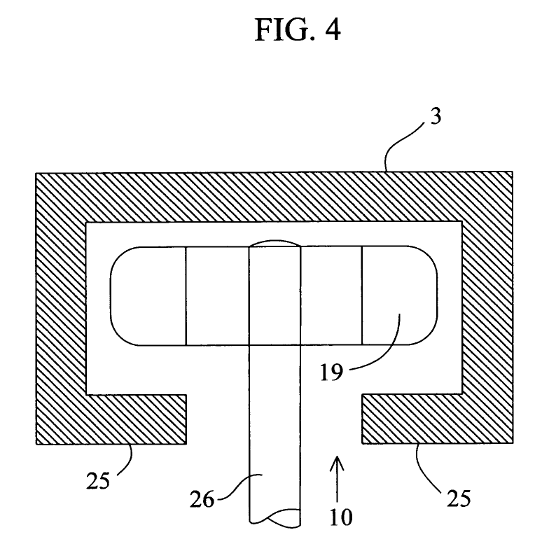

FIG. 4 depicts a cross section view B-B through one of the elongated front legs 3 of the ladder like frame, wherein the open face of the ‘U’ channel has extended opposing roller retention faces 25 secured to the channel and partially closing the opening in the ‘U’ channel face, leaving a slot 10 into the channel between the retention faces, the retention faces preventing the roller wheel 19 within the channel from withdrawing through the slot 10 in the channel, the slot sized to permit the axle 26 to extend outwards from the slot to the movable platform trolley. The slot smaller in width than the roller wheel diameter such that the roller wheel is retained within the channel.

FIG. 5 depicts a an enlargement of the transport wheels mounted near the front edge of the movable platform in accordance with the inventive disclosures herein. FIG. 5 depicts the view taken along detail ‘C’ of FIG. 1. Movable load platform member 11 is provided with wheels 35, mounted on opposing sides at the front of platform 11. Load bearing axle support housing 36 has a top face 37 secured to the bottom of the load platform 11. Axle 38 is secured to the axle support stand 36 and extends outwards beyond the side edge of platform 11. Transport wheel 35 is rollably secured to the axle 38 so that the wheel is free to roll.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, electrical and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A free-standing electric human lift apparatus comprising:
a ladder-like frame having the general form of a three legged orchard ladder, the ladder-like frame comprising:
a fixed top platform member;
two opposing substantially parallel distally spaced elongated front legs, top end of the legs connected to opposing sides of the top platform member, the legs having a track substantially along the length of the legs, the track providing a guide track for a movable load bearing platform; and
a stabilizing back leg pivotally connected at a top end to the platform member, the stabilizing leg stabilizing the ladder-like frame, providing a generally ‘A’ shaped step ladder-like side profile to the ladder-like frame;
a ladder leveling means secured to a bottom portion of the front legs, the leveling means for leveling the ladder-like lift apparatus when resting upon an uneven surface;
the movable load bearing platform for raising or lowering a human or material load on the ladder-like human lift apparatus, the movable platform comprising:
a trolley frame having two substantially parallel distally spaced elongated trolley arms, each arm having two opposing ends;
four axles, each axle having a first end secured to an opposing end of the trolley arms;
four roller wheels one for each axle, each roller having a cylindrical bearing for rolling on the axle, the roller circumference and size adapted to roll within the track of the elongated front legs of the ladder-like frame, the roller fix to the axle such that the roller spins freely on the axle;
a substantially horizontal load bearing platform member having a ridged slip resistant surface for supporting a human thereon, the load platform member secured on opposing sides to the opposing arms of the trolley frame;
a substantially horizontal elongated leg support having two ends, each secured to opposing trolley arm, the leg support positioned above the load platform such as to provide leaning leg support to a human standing on the load platform; and
two transport wheels rollably secured proximate to a front edge of the load bearing platform at opposing sides of the platform, wherein the electric human lift can be tilted forward onto the transport wheel and balanced thereon when rolling the electric human lift from place to place;
an electrically motor driven means of raising and lowering the movable platform, the electrically driven means secured to the ladder-like frame;
a wireless remote control transmitter having controls thereon to command the movable platform to raise or lower, the remote control transmitter having a support clip attached thereto to allow the remote control to be clipped onto a belt, strap or pants pocket of an electric lift operator;
a wireless remote control receiver and motor controller unit secured to the ladder-like frame, the receiver for receiving the raise lower commands, the controller for energizing the motor in response to the commands, the controller selectively rotating the output shaft of the motor to raise or lower the moveable platform;
a power supply means for providing electric power to operate the winch and receiver, said power supply means electrically connected to said receiver and motor; and
a brake means, said brake means engaging to prevent the motor driven means from rotating under the weight of the load on the movable platform, the brake means releasing during commanded operation of the winch and re-engaging after the command completes, the brake means being of a fail-safe type energize to release brake type.

2. The electric human lift apparatus of claim 1, wherein the electrically motor driven means comprises:
a winch secured to the ladder-like frame, the winch driven by an output shaft of the motor, the winch having and driving a cable drum; and
a pulley and cable means, the cable means secured at one end of the movable platform, the cable means windably received at an opposing end upon the cable drum of the winch, the winch operating in response to the commands.

3. The electric human lift apparatus of claim 2, wherein the ladder leveling means comprises:
two ladder leveling devices, one on a bottom portion of each front leg, each leveling device comprising:
a ‘U’ shaped channel leveling member having a slot through a portion of a back wall of the channel, the channel of the leveling member sized and adapted to be slidably received over a bottom portion of the front leg, the leveling member slidable along the leg to adjust the length of the leg so as to extend the leg and level the ladder-like frame on an uneven surface;
a threaded rod secured at one end to a bottom portion of the front leg, and projecting outwards through the slot of the leveling member; and
a threaded hand adjustable tensioning knob threadably received onto an outwards end of the threaded rod, the tensioning knob compressing the leveling member to the leg, frictionally fixing the leg extension for leveling the ladder-like frame.

4. The electric human lift apparatus of claim 2, wherein the ladder-like frame member further comprises:
a substantially flat base plate secured to a bottom end of the front legs, the base having the winch and electrically driven drive means secured thereon.

5. The electric human lift apparatus of claim 4, wherein the electrically driven drive means comprises:
a motor secured to the base plate of the ladder, the motor having an output shaft connected to the winch.

6. The electric human lift apparatus of claim 5 wherein the pulley and cable means comprises:
a first pulley wheel, the pulley wheel being rotably mounted to an underside of the fixed top platform member;
a cable threaded over and riding on the first pulley wheel, a first end of the cable secured to the moveable platform, a second end of the cable secured to and windably received upon the cable drum of the winch, wherein the cable winds or unwinds from the drum according to the commands.

7. The electric human lift apparatus of claim 6 wherein the power supply means comprises conventional 115 volt electrical utility power supplied through a conventional power cord.

8. The electric human lift apparatus of claim 6 wherein the power supply means comprises a rechargeable storage battery.

9. The electric human lift apparatus of claim 8 wherein the storage battery comprises one or more lead acid type 12 volt storage batteries.

10. A free-standing electric human lift apparatus comprising:
a ladder-like frame having the general form of a three legged orchard ladder, the ladder-like frame comprising:
a fixed top platform member;
two opposing substantially parallel distally spaced elongated front legs, top end of the legs connected to opposing sides of the top platform member, the legs having a ‘U’ shaped channel cross section, the ‘U’ shaped channel forming a guide track for a movable platform; and
a stabilizing back leg pivotally connected at a top end to the platform member, the stabilizing leg stabilizing the ladder-like frame, providing a generally ‘A’ shaped step ladder-like side profile to the ladder-like frame, wherein the ladder-like frame has a height of between 8 to 12 feet and wherein the distal spacing between the elongated front legs is nominally 2 foot and wherein the legs comprise aluminum;
two ladder leveling devices, one on a bottom portion of each front leg, each leveling device comprising:
a ‘U’ shaped channel leveling member having a slot through a portion of a back wall of the channel, the channel of the leveling member sized and adapted to be slidably received over a bottom portion of the front leg, the leveling member slidable along the leg to adjust the length of the leg so as to extend the leg and level the ladder-like frame on an uneven surface;
a threaded rod secured at one end to a bottom portion of the front leg, and projecting outwards through the slot of the leveling member; and
a threaded hand adjustable tensioning knob threadably received onto an outwards end of the threaded rod, the tensioning knob compressing the leveling member to the leg, frictionally fixing the leg extension for leveling the ladder-like frame;
the movable load bearing platform for raising or lowering a human or material load on the ladder-like human lift apparatus, the movable platform comprising:
a trolley frame having two substantially parallel distally spaced elongated trolley arms, each arm having two opposing ends;
four steel axles, one for each roller, each axle having a first end secured to an opposing end of the trolley arms;
four steel roller wheels one for each axle, each roller having a cylindrical bearing for rolling on the axle, the roller circumference and size adapted to roll within the ‘U’ shaped channel guide track of the elongated front legs of the ladder-like frame, the roller fixed to the axle such the roller spins freely on the axle;
a substantially horizontal load platform member having a ridged slip resistant surface for supporting a human thereon, the load platform member secured on opposing sides to the opposing arms of the trolley frame;
a substantially horizontal elongated leg support having two ends, each secured to opposing trolley arm, the leg support positioned above the load platform such as to provide leaning leg support to a human standing on the load platform; and
two transport wheels rollably secured proximate to a front edge of the load bearing platform at opposing sides of the platform, wherein the electric human lift can be tilted forward onto the transport wheel and balanced thereon when rolling the electric human lift from place to place;
a substantially flat base plate secured to a bottom end of the front legs;
a motor secured to a base plate of the ladder-like frame;
a winch secured to the base plate of the ladder-like frame, the winch driven by an output shaft of the motor, the winch having and driving a cable drum;
a wireless remote control transmitter having controls thereon to command the movable platform to raise or lower;
a wireless remote control receiver and motor controller unit secured to a base plate, the receiver for receiving the raise and lower commands, the controller for energizing the motor in response to the commands, the controller selectively rotating the output shaft of the motor to raise or lower the moveable platform;
one or more automotive 12 volt rechargeable storage batteries secured to the base plate, the battery for providing electric power to operate the winch and receiver, said battery electrically connected to said receiver and motor;
a first pulley wheel, the pulley wheel being rotably mounted to an underside of the fixed top platform member;
a cable threaded over and riding on the first pulley wheel, a first end of the cable secured to the moveable platform, a second end of the cable secured to and windably received upon the cable drum of the winch, wherein the cable is winds or unwinds from the drum according to the commands; and
a brake means, said brake means engaging to prevent the drum under the weight of the load on the movable platform, the brake means releasing during commanded operation of the winch and re-engaging after the command completes, the brake means being of a fail-safe type energize to release brake type.

11. The electric human lift apparatus of claim 10, wherein the open face of the ‘U’ channel has extended opposing roller retention faces secured to the channel and partially closing opening in the ‘U’ channel face, leaving a slot into the channel between the retention faces, the retention faces preventing the roller wheel within the channel from withdrawing through the slot in the channel, the slot sized to permit the axle to extend between the movable platform trolley and roller wheel retained within the channel but to be smaller than the diameter of the roller wheel such as to retain the roller wheel captured within the channel.
